(19) United States
(12) Patent Application Publication
(10) Pub. No.: US 2012/0057135 A1
(43) Pub. Date: Mar. 8, 2012

(54) Low power and low cost projection system

(76) Inventor: Sudarshan Kumar, Fremont, CA (US)

(21) Appl. No.: 12/801,468

(22) Filed: Sep. 7, 2010

(51) Int. Cl. G03B 21/14

(52) U.S. Cl. 353/31

(57) ABSTRACT

A system comprising of low cost and low power projection engine comprising of means of producing non-coherent light source, means of condensing non-coherent light into narrow beams, means of focusing and scanning narrow beam light on screen where as image is projected on screen by producing light for each pixel of image. Source of non-coherent light can be LED.

This patent application benefits from the provisional patent application with application Ser. No. 61/213429 filed on Jun. 8, 2009.

### FIELD

The present disclosure relates to the use of low power and low cost projection systems and micro displays.

### BACKGROUND

Projections systems are used widely in the industry, home and office. Use of rear projection TV (television) and video projectors for projecting images and videos on screens are very good example of projection systems. Projection systems are also used in industry such as in laser printers for copying images and text on paper. Projection systems are used to project laser beam to make masks used in semiconductor industry. In case of video projectors, light engine used for projections are very expensive, requires lots of power and required a very high bandwidth. High bandwidth requirement limits the performance of these systems. Some times multiple light engines are used in the projector to fix bandwidth limitation issue resulting in higher cost and higher power consumption. Attempts has been made to make cheaper and compact laser based projector using 2D scanning mirror to scan the laser light in horizontal and vertical direction just like display based on cathode ray tube. Here low intensity of image due to legal limit on intensity becomes an issue. Present invention using different safer light source reduces the cost of projection system, reduces power requirement and reduces the bandwidth required to project high quality image.

### BRIEF DESCRIPTION OF THE DRAWINGS

The present invention is illustrated by the way of example and not by way of limitation, in the figures of the accompanying drawings

FIG. 1 is block diagram of laser based prior art projection system.

FIG. 2 is block diagram of projection system containing an embodiment of present invention.

FIG. 3a shows the front view of light source before it goes through condenser lens.

FIG. 3b shows front view of light source after it has gone through condenser lens.

FIG. 4 shows another embodiment of present invention where condenser lens is not used.

### DESCRIPTION OF EMBODIMENTS

Following disclosure describes the low power projection engine. In the following example, very simplified examples and operations are described in order to provide a thorough understanding of the present invention. In some instances, details have been omitted in order not to obscure invention. It will be appreciated by one skilled in the art that the invention can be practiced in other ways without details described here.

Typical projection system consists of a light source and light engine containing array of pixel which control the light being reflected or transmitted based pixel of image it is projecting. For a mirror based light engine, light is reflected by mirror in desired direction to be on and light for that pixel to be projected on screen. When light is reflected in other direction by pixel mirror, then it is off That means light for that pixel does not go to screen. Here intensity of light in a pixel is controlled by controlling on and off time for that pixel mirror. For LCD (liquid crystal display) based light engine, there is LCD for each pixel which open or closes in response to voltage applied to it. Here also control of light is digital in the sense that either it allows the light to pass through it or to block the light completely. Here also intensity of light in a pixel is controlled by controlling on and off time for the LCD pixel. These display engines have several issues.

First one is cost. As an example of HD resolution of 1920 by 1080, size pixel array in light engine can be very large. For 10 u by 10 u pixel size, array size can be 19 mm by 10.8 mm. With chip so big, it is very costly. Another implication of a large chip is yield loss. As a result cost of these light engines are very high.

Second issue is bandwidth required for a projection system. In case of DLP or LCD light engine, pixel area is limited. So amount of circuit that can be put in pixel is limited. As a result only one bit of intensity/brightness control can be stored in a pixel. Brightness is controlled digitally by making pixel on and off in response to one bit stored in pixel as discussed above. Since there is not much storage in a pixel, each individual bit of intensity control need to be brought in a pixel one by one to display a complete frame. As a result these display engines requires up to 50 Gb/s bandwidth. To lower the bandwidth requirement, these engines reduces the number of gray scales, so that there are only fewer bits for intensity control for each pixel. This is why DLP or LCD based projection systems are bandwidth limited.

Third issue is power issue. DLP or LCD based light engines are operated at high voltages in order to operate LCD or micro mirror. This together with higher bandwidth requirement makes these light engines very power hungry. In case of micro mirror, there are other two issues. One is reflectivity of mirror which is about 60%. Other one is wasted light when micro mirror is in off state. For LCD based light engine, similar issue of transitivity and wastage of light in pixel's off state are there. As a result you need much brighter light source for a given desired brightness of the projected image. This results in even more wasted power.

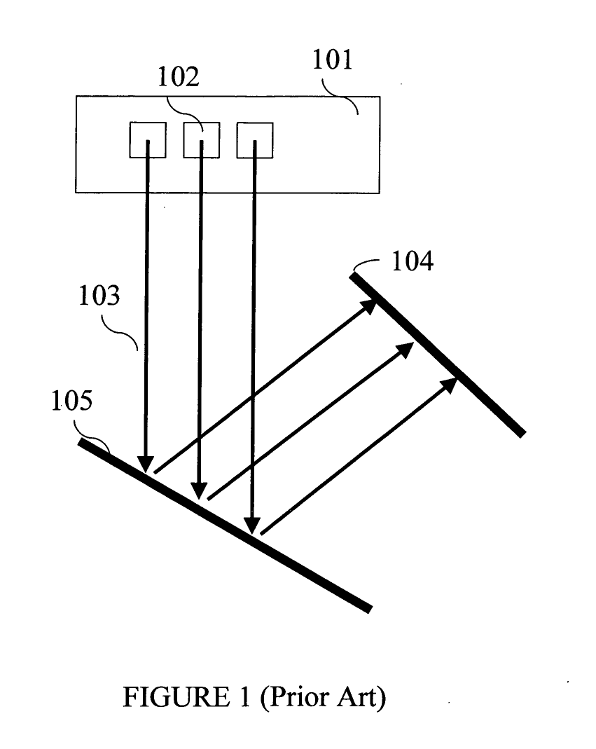

To reduce cost and power, laser based projector engine as shown in FIG. 1 has been tried. The term laser is an acronym for “ light amplification by stimulated emission of radiation”. Laser light is usually spatially coherent and can travel in narrow beam without diverging. Here in this example in FIG. 1, light source is made of three laser beams generating three primary color which can be used to create a color pixel of a color image. These three beams are time multiplexed among pixels and are scanned in horizontal and vertical fashion in such a way that it generates all the pixels of the image on screen 104. This time multiplexing is achieved by the scanning laser beams in two dimensions on screen by using 2D (two dimensional) scanning mirror 105. Advantage of this approach is that light engine is very simple and less costly. It contains laser source and scanning mirror. Sometimes a combining optics may be use to combine all three laser beams in one line so that system design is lot simpler. Laser beam do not need focusing optics as it is always in focus when it hits screen. Disadvantage of this approach is that the intensity of image is low as it is limited by the legal limit on intensity of laser beam. Cost of laser sources are very high and there is problem with visual quality due to speckle effect.

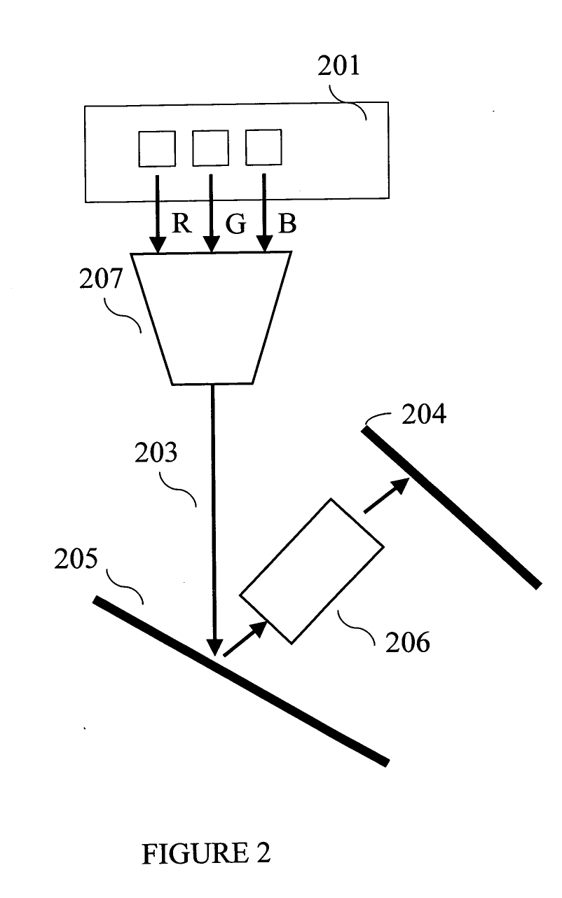

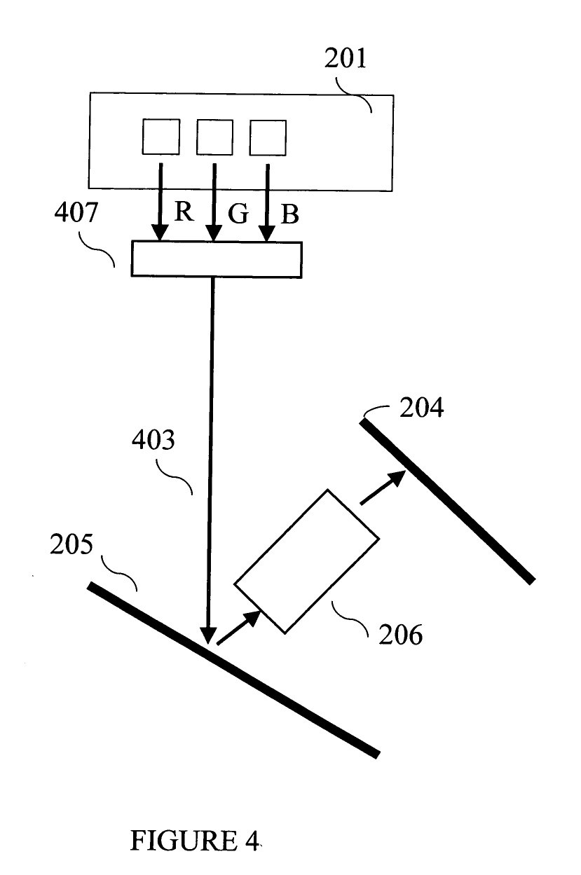

Present invention eliminates all the disadvantages of laser based projection engine as described above. It uses LED (Light Emitting Diode) based light source which is non-coherent and do not have problem with speckle and legal intensity limit. Cost of LED light sources is much lower than that of laser. In fact any non-coherent light source capable of meeting this application can be used. An embodiment of present invention is FIG. 2. Usually area of LED light source 201 is big. Even though LED light source can be projected on the screen without condenser lens it will make optics and mirror bigger and also overall design will be complicated. This scheme which does not use condenser lens is reflected in yet another embodiment of present invention as shown in FIG. 4, where image of light source is projected on the screen 204 using optics 206 and 407. In FIG. 4, light source R (red), (G) Green and B (Blue) can be being focused as individual image on screen 204. Same purpose can be accomplished by combining these three light beam in to one beam using optics 407 and then by focusing the combined beam on the screen 204 using optics 206 and scanning mirror 205.

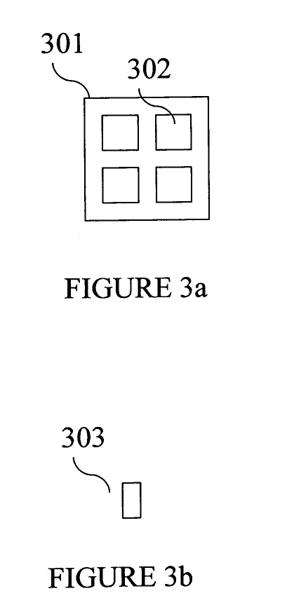

Better alternative is using condenser lens 207 as shown in example on FIG. 2. In this example, condenser lens 207 collects all light beams of all the color namely R(red), (G) Green and B (Blue) and creates a combined narrow beam of light that can be scanned by 2D (two dimensional) scanning mirror 205 and can be projected by small optics 206 on screen 204. In this example scanning mirror 205 and projecting optics 206 has been shown as separate entity. In fact scanning mirror can be sitting inside optics with some optical lens in front of mirror and some after it. Another alternative could be that projecting lens is placed first and then scanning mirror is placed in the path of beam. This scheme will be just reverse of what is shown in FIG. 2. FIG. 3a is the front cross section of LED light source being fed into condenser lens. Here four light sources are 302 is used. Each light sources can be of different colors to create color image on the screen. Condenser lens combines all these beams of light and produces a narrow beam of light as shown in FIG. 3b. Typically LED light source may not be uniform. But condensed beam is more uniform in cross section. Because of smaller beam cross section, smaller scanning mirror and smaller projecting optics is required in this case. This way very small projectors such as pico projectors can be made using this embodiment of present invention. Shape and size of cross section of light beams as shown in FIG. 3a can be different. It can have various shape such as rectangle, square, oval, circle etc It can also have various sizes that is suitable for optimum optics design. Scanning mirror 205 as shown in FIG. 2 and FIG. 4. can be build by a single mirror capable of scanning in two dimensions or by two single dimension scanning mirror. In the example in FIG. 2 and FIG. 4, LED light source is used. In fact any other light source capable of generating multiple color and capable of switch on/off can be used. Light engine described in present invention can be use in various systems needing image to be projected or displayed. Such system could be industrial, medical, entertainment and business systems. Example of entertainment systems comprises of television, movie projector, phone projector, pico projectors. This light engine can be used in systems needing curve display.

In the foregoing specification, the invention has been described with reference to specific exemplary embodiments thereof. It will, however, be evident that various modifications and changes may be made thereto without departing from the broader spirit and scope of this invention. The drawings are accordingly to be regarded in an illustrative rather than a restrictive sense.

What is claimed is:

1. A system comprising of projection engine which further comprising of
means of producing non-coherent light for each pixel
means of focusing and scanning light on screen
where as image is projected on screen by producing light for each pixel of image in sequence, by focusing light for each pixel on screen and by scanning produced light across the screen so that all pixels are illuminated on screen in time multiplexed fashion to form image.

2. The said means of producing non-coherent light as set forth in claim 1 comprises of color light source.

3. The said means of producing non-coherent light as set forth in claim 2 comprises of color LED light source.

4. The said means of producing non-coherent light as set forth in claim 3 comprises of at least RED, GREEN or BLUE color LED light source.

5. A system comprising of projection engine which further comprising of
means of producing non-coherent light
means of condensing non-coherent light into narrow beams
means of focusing and scanning narrow beam light on screen
where as image is projected on screen by producing light for each pixel of image in sequence, by condensing said light into narrow beam, by focusing light for each pixel on screen and by scanning said narrow light beam across the screen so that all pixels are illuminated on screen in time multiplexed fashion to form image.

6. The said means of producing non-coherent light as set forth in claim 5 comprises of color light source.

7. The said means of producing non-coherent light as set forth in claim 6 comprises of color LED light source.

8. The said means of producing non-coherent light as set forth in claim 7 comprises of at least RED, GREEN or BLUE color LED light source.

9. A system comprising of projection engine which further comprising of
means of producing non-coherent light of plurality of color beams
means of combining plurality of color beams into fewer beams
means of focusing and scanning combined light beams on screen
where as color image is projected on screen by producing light beams of plurality of colors for each pixel of image in sequence, by combining said plurality of color beams into fewer beams, by focusing said combined light beams for each pixel on screen and by scanning said combined light beams across the screen so that all pixels are illuminated on screen in time multiplexed fashion to form image.

10. The said means of producing non-coherent light as set forth in claim 9 comprises of color LED light source.

11. The said means of producing non-coherent light, as set forth in claim 10 comprises of at least RED, GREEN or BLUE color LED light source.

12. The said means of combining plurality of color beams as set forth in claim 9 produces a single combined beam of light.
